(19) United States
(12) Patent Application Publication
(10) Pub. No.: US 2025/0356254 A1
(43) Pub. Date: Nov. 20, 2025

(54) METHOD AND DEVICE FOR NON-INTRUSIVE AGGREGATION AND OPTIMAL CONTROL OF FLEXIBLE LOADS

(71) Applicant: TSINGHUA UNIVERSITY, Beijing (CN)

(72) Inventors: Guangchun RUAN, Beijing (CN); Haiwang ZHONG, Beijing (CN); Yiliu HE, Beijing (CN); Qing XIA, Beijing (CN); Chongqing KANG, Beijing (CN)

(21) Appl. No.: 18/880,920

(22) PCT Filed: Sep. 15, 2023
(86) PCT No.: PCT/CN2023/119007

§ 371 Date: Jan. 3, 2025

(30) Foreign Application Priority Data
Sep. 16, 2022 (CN) 202211128637.X

(51) Int. Cl. G06N 20/00; G06F 18/2132; G06Q 50/06

(52) U.S. Cl. CPC G06N 20/00; G06F 18/21326; G06Q 50/06

(57) ABSTRACT

A computer-implemented method is used for non-intrusive aggregation and optimal control of flexible loads. The method includes: constructing first and second models oriented to the flexible loads; generating an incentive price for a current round, and inputting the incentive price respectively into the first and second models to output a real-time response and a real-time matrix; if a constraint is satisfied based on the real-time response and the real-time matrix, determining the incentive price for the current round is optimal, and the real-time consumption is optimal; if the constraint is not satisfied, constructing a third model based on the incentive price for the current round, the real-time response and the real-time matrix, and obtaining an optimal incentive price and an optimal response based on the third model; and performing non-invasive aggregation and optimal control of the flexible loads based on the optimal incentive price and the optimal response.

### CROSS-REFERENCE TO RELATED APPLICATIONS

This application is a national stage entry under 35 U.S.C. § 371 of International Application No. PCT/CN2023/119007, filed on Sep. 15, 2023, which claims priority to Chinese Patent Application No. 202211128637.X, filed on Sep. 16, 2022, the entire disclosures of which are hereby incorporated herein by reference.

### TECHNICAL FIELD

The present disclosure relates to the technical field of electric power demand-side response, and in particular to a method and a device for non-intrusive aggregation and optimal control of flexible loads.

### BACKGROUND

The renewable-dominated power system is an important guarantee for realizing carbon peaking and carbon neutrality goals. There are urgent needs to develop demand-side flexibility resources which have not yet been fully activated, in order to integrate a high penetration of renewable energy. In particular, fully grasping the opportunity of spot market construction and developing price-based demand response technologies have become an important means to enhance the demand-side flexibility.

The demand-side flexibility resources mainly include a variety of flexible loads such as electric vehicles, smart buildings, multi-energy microgrids, etc. These resources generally have massive and heterogeneous features, and are distributed in a dispersed manner, which need efficient aggregation and optimization processing to form scalable and controllable resources. In order to adapt to the above features, there is an urgent need to develop highly efficient demand response technologies for aggregation and optimization, to achieve a coordinated control of the massive and heterogeneous resources with the highest possible computational accuracy and the lowest possible computational cost.

However, the related art relies on the precise parameters uploaded from users, and the modeling performance is strongly affected by the parameter accuracy. For example, when the operational parameters are distorted or maliciously misreported, neither a centralized direct load control algorithm nor a distributed decomposition coordination algorithm can obtain a real system optimal scheme; when the operational parameters are seriously distorted, the aggregation and optimization results may even violate security constraints of the system, resulting in a serious waste of flexibility resources.

At present, some projects try to improve the accuracy of operational parameters based on high-precision user modeling, but most of them are just pilot projects with a small pilot scale, a high cost, and a low willingness of users to participate. The underlying reason is that the research data actually involves in many private information such as a typical energy use habit and a load scheduling plan. With the gradual increase of privacy protection awareness in recent years, the applicability of the refined research method will be seriously limited. Therefore, there is an urgent need to develop a technique for non-intrusive aggregation and optimal control of flexible loads with a high aggregation and optimization accuracy.

### SUMMARY

According to a first aspect of the present disclosure, a method for non-intrusive aggregation and optimal control of flexible loads is provided, including: obtaining a feature identification model oriented to the flexible loads, in which an input of the feature identification model is an incentive price, and an output of the feature identification model is a responsive electricity consumption; obtaining an elasticity estimation model oriented to the flexible loads, in which an input of the elasticity estimation model is the incentive price, and an output of the elasticity estimation model is a virtual elasticity matrix; obtaining an incentive price for a current round in real time, outputting a real-time responsive electricity consumption by inputting the incentive price for the current round into the feature identification model, and outputting a real-time virtual elasticity matrix by inputting the incentive price for the current round into the elasticity estimation model; determining whether a system security constraint is satisfied based on the real-time responsive electricity consumption and the real-time virtual elasticity matrix; in response to determining that the system security constraint is satisfied, determining the incentive price for the current round is an optimal incentive price, and the real-time responsive electricity consumption is an optimal responsive electricity consumption; in response to determining that the system security constraint is not satisfied, constructing an incremental optimization model based on the incentive price for the current round, the real-time responsive electricity consumption and the real-time virtual elasticity matrix, and obtaining the optimal incentive price and the optimal responsive electricity consumption based on the incremental optimization model; and performing non-invasive aggregation and optimal control of the flexible loads based on the optimal incentive price and the optimal responsive electricity consumption.

According to a second aspect of embodiments of the present disclosure, a device for non-intrusive aggregation and optimal control of flexible loads is provided, including: at least one processor; and a memory communicatively coupled to the at least one processor; in which the memory stores instructions executable by the at least one processor, the instructions are executed by the at least one processor to cause the at least one processor to perform the method according to the first aspect.

According to a third aspect of embodiments of the present disclosure, a non-transitory computer-readable storage medium is provided, in which the instruction in the computer-readable storage medium, when executed by the processor of the electronic device, enables the electronic device to perform the method according to the first aspect.

Additional aspects and advantages of the present invention will be set forth in part in the following description, and will be obvious from the following description, or will be learned by practice of the present invention.

### BRIEF DESCRIPTION OF THE DRAWINGS

The above-mentioned and/or additional aspects and advantages of the present disclosure will become apparent and readily appreciated from the following description of embodiments, in conjunction with the accompanying drawings.

FIG. 1 is a flowchart illustrating a method for non-intrusive aggregation and optimal control of flexible loads according to an embodiment of the present disclosure.

FIG. 2 is a flowchart illustrating another method for non-intrusive aggregation and optimal control of flexible loads according to an embodiment of the present disclosure.

FIG. 3 is a block diagram illustrating an apparatus for non-intrusive aggregation and optimal control of flexible loads according to an embodiment of the present disclosure.

FIG. 4 is a block diagram illustrating a device for non-intrusive aggregation and optimal control of flexible loads used to implement the above-mentioned method according to an embodiment of the present disclosure.

### DETAILED DESCRIPTION

Reference will now be made in detail to the exemplary embodiments, examples of which are illustrated in the accompanying drawings. When the following description refers to the accompanying drawings, the same numerals in different drawings refer to the same or similar elements unless otherwise indicated. The implementations described in the following exemplary embodiments do not represent all implementations consistent with the embodiments of the present disclosure. Rather, they are merely examples of devices and methods consistent with aspects of the embodiments of the disclosure as recited in the appended claims.

In the description, terms such as “an embodiment,” “some embodiments,” “an example,” “a specific example,” or “some examples” mean that a particular feature, structure, material, or feature described in conjunction with the embodiment or example is included in at least one embodiment or example of the present disclosure. Thus, the exemplary descriptions of the above terms throughout this specification are not necessarily referring to the same embodiment or example of the present disclosure. Furthermore, the particular features, structures, materials, or features may be combined in any suitable manner in one or more embodiments or examples. In addition, without conflicting with each other, those skilled in the art may merge and combine different embodiments or examples and features of different embodiments or examples described in this specification.

Additionally, the terms “first” and “second” are used for descriptive purposes only and are not to be construed as indicating or implying relative importance or implicitly specifying the number of technical features indicated. Thus, a feature defined with the terms “first”, “second” may expressly or implicitly include at least one such feature. In the description of the present disclosure, “a plurality of” means at least two, such as two, three, etc., unless otherwise expressly and specifically limited. It should also be understood that the term “and/or” as used in the present disclosure refers to and encompasses any or all possible combinations of one or more of the listed items in association.

The embodiments of the present disclosure are described in detail below. Examples of the embodiments are shown in the accompanying drawing throughout which the same or similar numbers indicate the same or similar components or components with the same or similar functions. The embodiments described below with reference to the accompanying drawings are exemplary, and are intended to explain the disclosure, but should not be understood as a limitation to the disclosure.

The present disclosure provides a method and a device for non-intrusive aggregation and optimal control of flexible loads, and a storage medium, with the main purpose of improving the aggregation and optimization accuracy of the flexible loads. The methods according to the present disclosure are mainly oriented to a load service provider, a load aggregation provider, an electric distribution network scheduling center, a microgrid control center, and other subjects, and can be used to improve the accuracy and efficiency of the coordinated control of flexible load clusters.

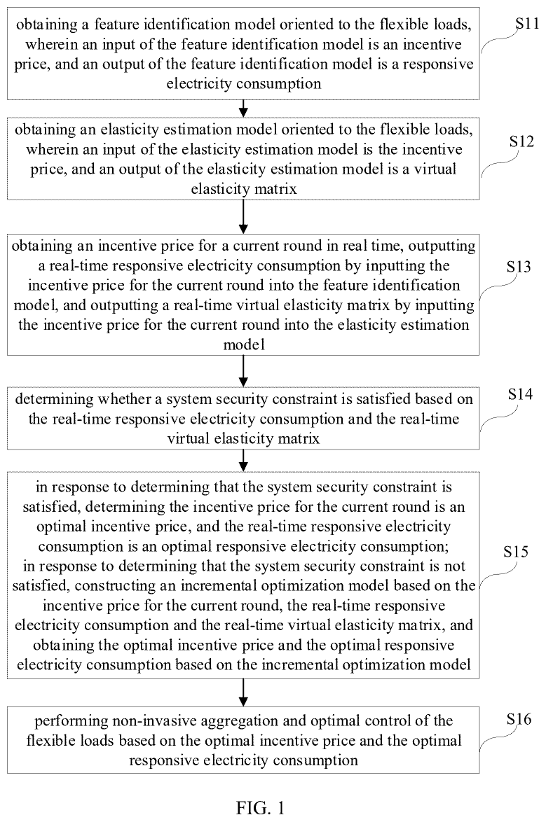

In a first embodiment, referring to FIG. 1, which is a flowchart illustrating a method for non-intrusive aggregation and optimal control of flexible loads according to an embodiment of the present disclosure.

As shown in FIG. 1, specifically, the method includes the following steps S11 to S16.

At S11, a feature identification model oriented to the flexible loads is obtained, in which an input of the feature identification model is an incentive price, and an output of the feature identification model is a responsive electricity consumption.

In the embodiment of the present disclosure, the feature identification model oriented to the flexible loads obtained at S11 may be a retained feature identification model oriented to the flexible loads that is read directly, or may be obtained by establishing and training a new model.

Specifically, at S11, the input of the established feature identification model is the incentive price, the output of the established feature identification model is the responsive electricity consumption, and the equation of the feature identification model is as follows:

$${\hat{D}}_{t} = {D}_{t} ( prc ) , ∀ t$$

In this equation, t is a first time sequence number, which takes a value ranging from 1 to T. prc denotes an incentive price vector, prc=[prc₁, prc₂, . . . , prc_{T}]. \hat{D}ₜ is a responsive electricity consumption (which is a total amount of aggregated electricity consumption of respective flexible loads) estimated at the time period t. Dₜ(⋅) is a mapping function representing price-response features of the flexible loads, which is an object to be identified in this step.

In some embodiments, at S11, the established feature identification model is a machine learning model oriented to the feature identification, in which the machine learning model may be a multi-input and multi-output machine learning model.

In some embodiments, the machine learning model is, for example, a neural network model. That is, a multi-input and multi-output neural network is used to model the mapping function so as to obtain the feature identification model. The plurality of inputs (i.e., multi-input) are incentive prices for a plurality of time periods, and the plurality of outputs (i.e., multi-output) are responsive electricity consumptions for respective time periods. For example, the inputs of the neural network model are incentive prices from the 1^{st} time period to the T^{th} time period, and the outputs are the responsive electricity consumptions from the 1^{st} time period 1 to the T^{th} time period.

In some embodiments, at S11, the intermediate layer structure of the multi-input and multi-output neural network model may be set flexibly according to the needs, and generally may be set as a plurality of layers, such as a fully connected layer, a convolutional layer, a pooling layer, etc., and in addition, an activation function of the neural network model may be selected according to the needs.

In some embodiments, at S11, in order to ensure the estimation effect of the multi-input and multi-output neural network model, a plurality of parameter combinations of the multi-input and multi-output neural network model may be selected. Each of the parameter combinations is a candidate parameter combination. In this way, the neural network hyperparameter optimization is subsequently performed for the different candidate parameter combination, and an optimal feature identification model as required is obtained by selection.

At S11, the established neural network model oriented to the feature identification is trained. Specifically, a first training dataset is formed from the incentive price and the responsive electricity consumption, a loss function of the neural network model is set to a mean square error function, and the neural network model oriented to the feature identification is trained using an algorithm such as a stochastic gradient descent algorithm or Adam algorithm based on the first training dataset. Various parameters of the various functions and algorithms involved in the training can be obtained from an initial configuration as described below. The data in the first training dataset may be obtained through a history database in the initial configuration.

In some embodiments, considering the training effect of the machine learning model is affected by more factors, and repeated debugging is usually required to obtain ideal results, the feature identification model at S11 adopts a hyperparameter optimization method in the training process. If the machine learning model is a neural network model, a hyperparameter optimization method for the neural network is used in the training process. Specifically, each of the candidate parameter combinations mentioned in this step is invoked one by one, and the neural network model with a different candidate parameter combination is repeatedly trained for a plurality of times. Then, the average performance is calculated, and a candidate parameter combination corresponding to an optimal average performance is taken as a first optimal parameter combination. The plurality of trainings are, for example, 5 trainings. The neural network model obtained after training based on the first optimal parameter combination is the required feature identification model.

In some embodiments, if a lower limit requirement of the machine learning model accuracy is obtained during the initial configuration, such as a lower limit requirement of the neural network estimation accuracy, there is a need to determine whether a model accuracy satisfies a corresponding requirement at S11 for the required feature identification model obtained by using the first optimal parameter combination. If the model accuracy cannot meet the corresponding requirement, then the candidate parameter combination needs to be expanded, additional training and testing are performed on the expanded candidate parameter combination, and the required feature identification model is re-determined until the model accuracy of the re-determined model meets the corresponding requirement.

At S12, an elasticity estimation model oriented to the flexible loads is obtained, in which an input of the elasticity estimation model is the incentive price, and an output of the elasticity estimation model is a virtual elasticity matrix.

In an embodiment of the present disclosure, before obtaining the elasticity estimation model oriented to the flexible loads at S12, virtual elasticity data is first generated using the feature identification model obtained at S11. Since the elasticity is not directly obtained by measurement but only approximate estimation, it is referred to as a virtual elasticity. The virtual elasticity is essentially a sensitivity representation of the price-response features of the flexible loads. The price-response features can be specifically represented by the virtual elasticity matrix, which has a dimension of T rows and T columns. The physical meaning of an element at the row t and the column τ is a sensitivity of the electricity consumption for the time period τ with respect to the electricity price for the time period t. Therefore, the corresponding virtual elasticity database is directly generated based on the definition of the virtual elasticity matrix, which maintains the same amount of data as the historical database in the initial configuration. It is generally accepted that the virtual elasticity matrix for the flexible loads should be symmetrical, however, since the machine learning model, such as the neural network model, are unable to avoid estimation errors, the generated virtual elasticity data are difficult to avoid the influence of the errors, and the natural symmetry of the elasticity matrix cannot be maintained. In order to reduce the influence of the errors, a method of symmetrized correction is introduced, and the specific equation of this correction method is as follows:

$$\hat{e} ls = \frac{els + {els}^{T}}{2}$$

In this equation, els is an originally generated matrix data, and a symmetrized matrix êls is constructed by averaging els with the transposed matrix els^{T} of els. Additionally, cuts are made to extreme values in the elasticity estimates, and the extreme values are generally determined using the 3-Sigma criterion.

In the embodiments of the present disclosure, before the step S12, generating the virtual elasticity data first using the feature identification model obtained at S11 specifically includes: inputting an incentive price in the historical database into the feature identification model to generate a responsive electricity consumption, directly generating corresponding virtual elasticity data based on the incentive price and the responsive electricity consumption generated, in accordance with the definition of the virtual elasticity matrix, and obtaining required virtual elasticity data by performing correction processing and extreme value reduction processing on the virtual elasticity data generated. The required virtual elasticity data is subsequently used for the training of the elasticity estimation model.

In an embodiment of the present disclosure, the elasticity estimation model oriented to the flexible loads obtained at S12 may be a retained elasticity estimation model oriented to the flexible loads that is read directly, or may be obtained by establishing and training a new model.

Specifically, at S12, the input of the established elasticity estimation model is the incentive price, the output of the elasticity estimation model is the virtual elasticity matrix, and the equation of the elasticity estimation model is as follows:

$${Ê}_{t τ} = {E}_{t τ} ( prc ) , ∀ t , ∀ τ$$

In this equation, t is a first time sequence number, which takes a value ranging from 1 to T. τ is a second time sequence number, which takes a value ranging from 1 to T. The first time sequence number t, and the second time sequence number τ correspond to a row number and a column number in the virtual elasticity matrix respectively, Ê_{tτ} is an estimated elasticity (i.e., the virtual elasticity data), specifically corresponding to an element in the virtual elasticity matrix at the row t and the column τ, E_{tτ}(⋅) is a mapping function representing the elasticity of the flexible loads, which is the object to be identified in this step.

In some embodiments, at S12, the established elasticity estimation model is a machine learning model oriented to elasticity estimation, in which the machine learning model may be a multi-input and multi-output machine learning model.

In some embodiments, the machine learning model is, for example, a neural network model. That is, a multi-input and multi-output neural network is used to model the mapping function so as to obtain the elasticity estimation model. The plurality of inputs (i.e., multi-input) are incentive prices for a plurality of time periods, and the plurality of outputs (i.e., multi-output) are virtual elasticity matrixes for respective time periods. For example, the inputs of the neural network model are incentive prices from the 1^{st} time period to the T^{th} time period, and the outputs are T² elasticity elements from the 1^{st} time period to the T^{th} time period. The estimated virtual elasticity matrix can be obtained by rearranging the output vector (i.e., the output elasticity elements).

In some embodiments, at S12, the intermediate layer structure of the multi-input and multi-output neural network model may be set flexibly according to the needs. In addition, considering that the elasticity estimation may have a difficult training, the generally selected intermediate layer structure is more complex compared to the intermediate layer structure of the neural network model at S11. Also, the activation function of the neural network model may be selected according to the needs.

In some embodiments, at S12, in order to ensure the estimation effect/performance of the multi-input and multi-output neural network model, a plurality of parameter combinations of the multi-input and multi-output neural network model may be selected. each of the parameter combinations is a candidate parameter combination. In this way, the neural network hyperparameter optimization is subsequently performed for the different candidate parameter combination, and an optimal elasticity estimation model as required is obtained by selection.

At S12, the established neural network model oriented to the elasticity estimation is trained. Specifically, a second training dataset is formed from the incentive price and the virtual elasticity matrix, a loss function of the neural network model is set to a mean square error function, and the neural network model oriented to the elasticity estimation is trained using an algorithm such as a stochastic gradient descent algorithm or Adam algorithm based on the second training dataset. Various parameters of the various functions and algorithms involved in the training can be obtained from the initial configuration. The incentive prices in the second training dataset may be obtained through the historical database in the initial configuration. The virtual elasticity matrixes in the second training dataset are the virtual elasticity data generated using the feature identification model in this step.

In some embodiments, considering the training effect of the machine learning model is affected by more factors, and repeated debugging is usually required to obtain ideal results, the elasticity estimation model at S12 adopts a hyperparameter optimization method in the training process. If the machine learning model is a neural network model, a hyperparameter optimization method for the neural network is used in the training process. Specifically, each of the candidate parameter combinations mentioned in this step is invoked one by one, and the neural network model with a different candidate parameter combination is repeatedly trained for a plurality of times. Then, the average performance is calculated, and a candidate parameter combination corresponding to an optimal average performance is taken as a second optimal parameter combination. The plurality of trainings is, for example, 5 trainings. The neural network model obtained after training using the second optimal parameter combination is the required elasticity estimation model.

In some embodiments, if a minimum accuracy requirement of the machine learning model is obtained during the initial configuration, such as a minimum estimation accuracy requirement of the neural network, there is a need to determine whether a model accuracy satisfies a corresponding requirement at S12 for the required elasticity estimation model obtained by using the second optimal parameter combination. If the model accuracy cannot meet the corresponding requirement, then the candidate parameter combination needs to be expanded, additional training and testing are performed on the expanded candidate parameter combination, and the required elasticity estimation model is re-determined until the model accuracy of the re-determined model meets the corresponding requirement.

In some embodiments, before obtaining the feature identification model oriented to the flexible loads at S11 and obtaining the elasticity estimation model at S12, the method further includes performing initial configuration. Performing the initial configuration may include checking a communication network state, importing a historical database, importing a historical empirical model, and reading various parameters and performance requirements for the aggregation and optimization. The imported historical empirical model may be a previously retained feature identification model and elasticity estimation model oriented to the flexible loads. The various parameters and performance requirements for the aggregation and optimization includes, but is not limited to, parameters of various functions and algorithms involved in training the model.

At S13, an incentive price for a current round is obtained in real time, a real-time responsive electricity consumption is outputted by inputting the incentive price for the current round into the feature identification model, and a real-time virtual elasticity matrix is outputted by inputting the incentive price for the current round into the elasticity estimation model.

In the embodiment of the present disclosure, an iterative algorithm is used and an iterative round coefficient is set in the step S13 and the subsequent steps. The iteration round coefficient may be represented by k. In case that the current round is the k^{th} round, the incentive price for the current round, i.e., the incentive price of the k^{th} round, may be expressed as prc(k). The incentive price prcₜ(k) for the current round at the time period t is input into the feature identification model obtained at S11 to output the real-time responsive electricity consumption, and the incentive price prcₜ(k) for the current round at the time period t is input into the elasticity estimation model obtained at S12 to output the real-time virtual elasticity matrix. The real-time responsive electricity consumption may be represented as Dₜ(prc(k)), and may be simplified as Dₜ(k), and the real-time virtual elasticity matrix may be represented as E_{tτ}(prc(k)), and may be simplified as E_{tτ}(k). Alternatively, a symbol of the equation of the feature identification model obtained at S11 and a symbol of the equation of the elasticity estimation model obtained at S12 may be adapted based on the iterative round coefficient.

In some embodiments, the input (i.e., the incentive price) of the feature identification model and the input (i.e., the incentive price) of the elasticity estimation model need to be set with an initial value when the feature identification model and the elasticity estimation model are called for the first time at S13, in which the initial value set may be initial incentive price data read in the initial configuration. When the feature identification model and the elasticity estimation model are called in subsequent iterations, the input of the feature identification model and the input of the elasticity estimation model are the incentive price for the current round obtained in real-time. The incentive price for the current round is input into each of the feature identification model and the elasticity estimation model, to output the real-time responsive electricity consumption (i.e., a real-time load response) and the real-time virtual elasticity matrix (i.e., an elasticity result).

At S14, it is determined whether a system security constraint is satisfied based on the real-time responsive electricity consumption and the real-time virtual elasticity matrix.

The system security constraint at S14 may be read from the various parameters and performance requirements for aggregation and optimization that are initially configured. Based on the real-time responsive electricity consumption and the real-time virtual elasticity matrix obtained at S13, it is calculated and determined whether the system security constraint is satisfied, in combination with an expression of the system security constraint. For example, a common system security constraint is a system capacity limit constraint, if a sum of all the real-time responsive electricity consumptions exceeds a given capacity limit value, the system security constraint is not satisfied; if the sum does not exceed the given capacity limit value, the system security constraint is satisfied.

In addition, when the system security constraint has a plurality of constraints at S14, there is a need to determine whether all the system security constraints are satisfied or not. If all the system security constraints are satisfied, states of the flexible loads at this time do not cause a system operation risk. However, all the system security constraints often cannot be satisfied, which is common in a situation where there are limited transmission channel resources of the system. In this case, it is necessary to continue to run iterative calculations to adjust the incentive price, which in turn changes the responsive electricity consumption of the flexible loads. After performing several rounds of iterations, each of the security constraints is finally satisfied.

At S15, in response to determining that the system security constraint is satisfied, the incentive price for the current round is determined as an optimal incentive price, and the real-time responsive electricity consumption is determined as an optimal responsive electricity consumption; in response to determining that the system security constraint is not satisfied, an incremental optimization model is constructed based on the incentive price for the current round, the real-time responsive electricity consumption and the real-time virtual elasticity matrix, and the optimal incentive price and the optimal responsive electricity consumption is obtained based on the incremental optimization model.

When the system security constraint is satisfied at S15, the incentive price for the current round is determined as the optimal incentive price, and the real-time responsive electricity consumption is determined as the optimal responsive electricity consumption, and non-intrusive aggregation and optimal control of the flexible loads is performed based on the optimal incentive price and the optimal responsive electricity consumption at S16. When the system security constraint is not satisfied, the incremental optimization model is constructed based on the incentive price for the current round, the real-time responsive electricity consumption, and the real-time virtual elasticity matrix of the current round, and the incremental optimization model is solved.

In response to determining that the system security constraint is not satisfied, constructing the incremental optimization model based on the incentive price for the current round, the real-time responsive electricity consumption and the real-time virtual elasticity matrix at S15, specifically includes the following steps S151 to S153.

At S151, an objective function of the incremental optimization model is constructed. The incremental optimization model is a kind of special model applied to aggregation and optimization of the flexible loads, and the core concept of the model is to transform a complex aggregation and optimization process into a series of computational phases, each of which is judging, based on a certain given state, how to achieve an improvement in an objective function value through state fine-tuning. In this way, a sequence of states that gradually improve the objective function value can be obtained after each of the computational phases performs the above judgement.

At each of the computational phases (i.e., each round), there is a need to update the incremental optimization model, the objective function of the incremental optimization model is as follows:

$$min {\sum }_{t} {D}_{t} ( k ) \cdot [ {prc}_{t} ( k + 1 ) - {prc}_{t} ( k ) ] + M {\sum }_{t} {Δ}_{t}$$

In this equation, Δₜ is an auxiliary variable used for constraint relaxation, and M is a sufficiently large penalty parameter, which typically takes the value of 104 or 106. The real-time responsive electricity consumption Dₜ(k) is provided by the feature identification model obtained at S11, which is capable of representing iterative co-training features of a neural network based optimization model. The objective function of the incremental optimization model embodies minimizing the system scheduling cost, in which the incentive price prcₜ(k) and the real-time responsive electricity consumption Dₜ(k) for the current round in the time period t are set as constants in the current round, and the incentive price prcₜ(k+1) for the next round in the time period t is an optimization variable.

At S152, constraints of the incremental optimization model are constructed. The incremental optimization model generally includes three types of constraints, which are a system security constraint, an incentive price iteration step constraint, and a variable value range constraint.

For the system security constraint, the system security constraint can be read from the various parameters and performance requirements for aggregation and optimization that are initially configured, and can be illustrated below with an example of a system capacity limit constraint. The equation of the system capacity limit constraint is as follows:

$${D}_{t} ( k ) + {\sum }_{τ} {E}_{t τ} ( k ) \cdot [ {prc}_{τ} ( k + 1 ) - {prc}_{τ} ( k ) ] \leq {CAP}_{t} + {Δ}_{t} , ∀ t$$

In this equation, CAPₜ is a capacity limit value for the time period t, which sometimes takes a constant value independent of time. prc_{τ}(k+1) is an incentive price for the next round in the time period τ. prc_{τ}(k) is an incentive price for the current round in the time period τ. Δₜ is an auxiliary variable used for constraint relaxation, which mainly serves to avoid the interruption of the optimization solution process when the security constraint is not feasible. Adding Δₜ for optimization always results in an optimized solution, and in case of Δₜ=0, it indicates the original security constraint is feasible; in case of Δₜ being not equal to 0, the original security constraint is not feasible. As easily seen above, the system capacity limit constraint also has the iterative co-training features of the neural network based optimization model. In addition, it should be noted again that the system security constraint has various forms, which are not limited to the above-mentioned forms. Other constraints can be similarly referred to the system capacity limit constraint, such as introducing auxiliary variables to perform relaxation of the modeling transformation.

The equation of the incentive price iteration step constraint is as follows:

$$‖ {prc}_{τ} ( k + 1 ) - {prc}_{τ} ( k ) ‖ \leq δ , ∀ t$$

In this equation, δ is a given upper limit of the iteration step, which can be obtained from the initial configuration. When δ is too large, it may easily lead to oscillations in the convergence process. When δ is too small, it may make the convergence speed slow. In practical application, a reasonable setting needs to be made according to experience.

The equation of the variable value range constraint is as follows:

$${prc}_{τ} ( k + 1 ) \geq {prc}_{τ} ( 0 ) , ∀ t$$

$${Δ}_{t} \geq 0 , ∀ t$$

In this equation, the variable value range constraint means the incentive price is not lower than an initial incentive price prc_{T}(0), and the auxiliary variable is a non-negative real number. In some embodiments, in addition to the above two value range constraints, an additional limiting constraint may be introduced based on special operating features of some of the flexible loads to ensure the system operates within a reasonable interval.

At S153, the incremental optimization model is constituted. The objective function constructed at S151 is combined with the series of constraints constructed at S152, to obtain the complete incremental optimization model. The incremental optimization model is generally a linear programming model, and in case some of the constraints are nonlinear constraints, the nonlinear constraints can be transformed into linear constraints by means of local linearization.

At S15, the incremental optimization model is solved after constructing the incremental optimization model. Since the incremental optimization model can be modeled as a linear programming model, the incremental optimization model can be efficiently solved using conventional optimization solving software.

In addition, since construction for the incentive price, the real-time responsive electricity consumption and the real-time virtual elasticity matrix in each round may be different, it is necessary to update and solve the incremental optimization model again in each round. That is, in the iterative process, the incremental optimization model needs to be updated and solved continuously. This method is also called as a solution technique based on sequential linear programming, which has the outstanding advantages of high solution efficiency, good robustness, and strong generality.

At S16, non-invasive aggregation and optimal control of the flexible loads is performed based on the optimal incentive price and the optimal responsive electricity consumption.

In the embodiments of the present disclosure, convergence may be further determined at S16. The convergence determination process includes: obtaining an optimal incentive price for an adjacent round, and determining whether a convergence stop condition is satisfied based on the optimal incentive price for the adjacent round; in response to determining that the convergence stop condition is satisfied, performing non-invasive aggregation and optimal control of the flexible loads based on the optimal incentive price and the optimal responsive electricity consumption; in response to determining that the convergence stop condition is not satisfied, updating the current round, and obtaining a new optimal incentive price and a new optimal responsive electricity consumption based on an updated incentive price for the current round obtained in real time.

For example, for the optimal incentive price obtained at S15, it is determined whether the optimal incentive price reaches the convergence stop condition, and the convergence needs to satisfy the following equation:

$${max}_{t} ‖ {prc}_{t} ( k + 1 ) - {prc}_{t} ( k ) ‖ \leq tol$$

In this equation, tol represents a boundary value of a convergence criterion, and when the incentive prices in two iterations (i.e., two rounds) are sufficiently close to each other, it is considered that the convergence has reached. Specifically, it is necessary to first calculate an absolute value error of the incentive price at each moment, and determine a size relationship between a maximum error among the absolute value errors and the boundary value of the given convergence criterion. In case that the maximum error is less than the boundary value, it indicates the incentive prices in two iterations are sufficiently close to each other and the algorithm has converged. When the convergence stop condition is satisfied, the results are organized and output, and non-intrusive aggregation and optimal control of the flexible loads is performed based on the optimal incentive price and optimal responsive electricity consumption. When the convergence stop condition is not satisfied, the iteration round coefficient is increased by 1 (which is k←k+1) after completing the necessary recording operation. After the current round value is updated, the method skips to the step S13 to carry out the next round of iterative computation, so as to obtain the new optimal incentive price and the new optimal responsive electricity consumption.

In addition, in the convergence determination process, it is also necessary to record various details of the calculation of the current round, including the incentive price and responsive electricity consumption obtained in the iteration, as well as various constraint checking and convergence checking records.

In some embodiments, organizing and outputting the results after the convergence stop condition is satisfied specifically means that, organizing and checking the aggregation optimization results and sending the optimal incentive price to each of the flexible loads. In addition, it is also necessary to organize the optimization results of the entire computation process and the process records, where the records specifically includes: (1) the optimal result obtained at S15, the optimal result including, for example, a solution state, an optimal incentive price, and an optimal aggregation electricity consumption (i.e., the optimal responsive electricity consumption) of the flexible loads; (2) the iterative calculation results for each round recorded in the convergence determination process, the iterative calculation results including, for example, a change trajectory of the incentive price, an iterative change amount of the incentive price, and a change trajectory of the aggregation electricity consumption; (3) all kinds of log reports during the whole operation process.

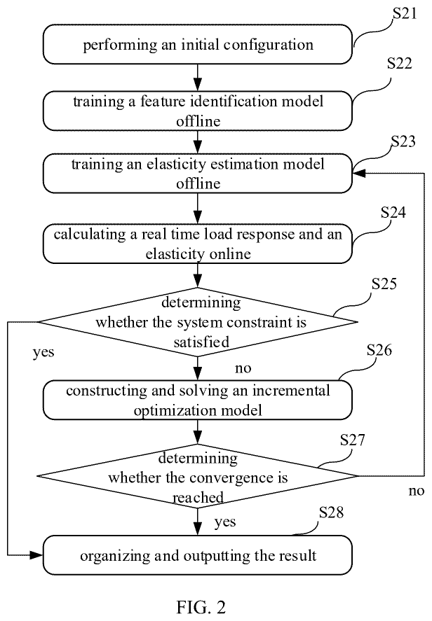

Referring to FIG. 2, it is a flowchart illustrating another method for non-intrusive aggregation and optimal control of flexible loads according to an embodiment of the present disclosure.

In some embodiments, as shown in FIG. 2, the method includes the following steps S21 to S28.

At S21, an initial configuration is performed.

The initial configuration at S21 generally includes four steps, which are checking a communication network state (S211), importing a historical database (S212), importing a historical empirical model (S213), and reading various parameters and performance requirements for aggregation and optimization (S214). It should be noted that the above steps S211 to S214 are not shown in FIG. 2 and the steps are used for facilitating the following description.

At S211, it is checked whether a communication line between a control center and each flexible load is unobstructed. For flexible loads with which the control center cannot communicate, a corresponding communication line with an abnormal status needs to suspended and operation and maintenance for the corresponding communication line is arranged as soon as possible. Meanwhile, the abnormal status of the corresponding communication line needs to be marked in a load list, so that the corresponding flexible load will not participate in the subsequent aggregation and optimal control.

At S212, the historical data refers to the incentive price and the responsive electricity consumption for the incentive price, and the data is recorded in the form of a single flexible load. That is, each group of data is a tuple containing the price and the corresponding electricity consumption. The historical database needs to be updated in time, and data records of nearly 3-5 years can usually be retained. These historical data will be subsequently used for feature identification of the flexible loads.

At S213, the historical empirical model refers to a model retained from a past service, and a typical model form is the neural network. In case that there is no past model retained, this step may be omitted.

At S214, the various parameters for aggregation and optimization include initial incentive price data, an equation of the system security constraint, system operation boundary parameters (such as a number of time periods, a capacity limit), parameters of the optimization algorithm (such as a boundary value of the convergence criterion, an iteration step constraint parameter), etc. The performance requirements include a lower limit requirement of the machine learning model accuracy (such as a lower limit requirement of the neural network estimation accuracy), computational speed requirements, computational accuracy requirements, configuration of logs recorded in the process etc.

At S22, the feature identification model is trained offline.

The feature identification model oriented to the flexible loads needs to be established or read at S22. In case that the historical empirical model at S213 includes the feature identification model oriented to the flexible loads, the feature identification model oriented to the flexible loads is read directly at S213, and the procedure skips to the step S23. In case that the historical empirical model at S213 does not include the feature identification model oriented to the flexible loads, a new feature identification model oriented to the flexible loads is established and trained in this step. The training of the new feature identification model oriented to the flexible loads can be referred to the relevant description at S11.

At S23, the elasticity estimation model is trained offline.

The elasticity estimation model oriented to the flexible loads needs to be established or read at S23. In case that the historical empirical model at S213 includes the elasticity estimation model oriented to the flexible loads, the elasticity estimation model oriented to the flexible loads is read directly at S213, and the procedure skips to step S24. In case that the historical empirical model at S213 does not include the elasticity estimation model oriented to the flexible loads, a new elasticity estimation model oriented to the flexible loads is established and trained in this step. The training of the new elasticity estimation model oriented to the flexible loads can be referred to the relevant description at S12.

At S24, the real-time load response and elasticity is calculated online.

Calculating the real-time load response and elasticity online at S24 includes: obtaining an incentive price for a current round in real time, outputting a real-time responsive electricity consumption by inputting the incentive price for the current round into the feature identification model, and outputting a real-time virtual elasticity matrix by inputting the incentive price for the current round into the elasticity estimation model. The details can be referred to the relevant description at S13.

At S25, it is determined whether the system constraint is satisfied.

The system constraint is a system security constraint at S25. The system security constraint can be read from the various parameters and performance requirements for aggregation and optimization that are initially configured. In case that the system security constraint is satisfied, then the procedure can directly skip to the step S28 for organizing and outputting the results. In case not satisfied, then the procedure proceeds to the step S26, and the specific details for the determination of the system constraint can be referred to the relevant description at S14.

At S26, the incremental optimization model is constructed and solved.

The construction and solution of the incremental optimization model at S26 can be referred to the relevant description at S15.

At S27, the convergence is determined.

When the convergence stop condition is satisfied at S27, then the procedure proceeds to the step S28. When the convergence stop condition is not satisfied, after completing the necessary recording operation, the round value is increased by 1 and the procedure skips to the step S24 to carry out the next round of iterative computation. The specific details of convergence determination can be referred to the relevant description at S16.

At S28, the result is organized and outputted.

The specific details of organizing and outputting the result at S28 can be referred to the relevant description at S16.

In the method according to the embodiments of the present disclosure, the feature identification model oriented to the flexible loads is obtained, in which the input of the feature identification model is the incentive price, and the output of the feature identification model is the responsive electricity consumption; the input of the elasticity estimation model is the incentive price, and the output of the elasticity estimation model is the virtual elasticity matrix; the incentive price for the current round is obtained in real time, the real-time responsive electricity consumption is output by inputting the incentive price for the current round into the feature identification model, and the real-time virtual elasticity matrix is output by inputting the incentive price for the current round into the elasticity estimation model; it is determined whether the system security constraint is satisfied based on the real-time responsive electricity consumption and the real-time virtual elasticity matrix; in response to determining that the system security constraint is satisfied, the incentive price for the current round is determined as the optimal incentive price, and the real-time responsive electricity consumption is determined as the optimal responsive electricity consumption; in response to determining that the system security constraint is not satisfied, the incremental optimization model is constructed based on the incentive price for the current round, the real-time responsive electricity consumption and the real-time virtual elasticity matrix, and the optimal incentive price and the optimal responsive electricity consumption are obtained based on the incremental optimization model; and non-invasive aggregation and optimal control of the flexible loads is performed based on the optimal incentive price and the optimal responsive electricity consumption. In this way, the feature identification model oriented to the flexible loads is combined with the elasticity estimation model oriented to the flexible loads and the incremental optimization model with the iterative co-training, to obtain the optimal incentive price and the optimal responsive electricity consumption, further to perform non-intrusive aggregation and optimal control of flexible loads. As a result, the aggregation and optimization accuracy of the flexible loads can be improved. In addition, considering the non-intrusive identification technique removes information reporting, a statistical method is used to establish an equivalent mapping relationship of the external features. The method of the present disclosure performs a series of developments based on this technique. Specifically, a new type of non-intrusive identification technique is established based on the neural network, which is applied to the identification task of the flexible load aggregation feature. The aggregation and optimization technique with the in-built identification model is further proposed, which is mainly oriented to an electric distribution network dispatching organization, a microgrid control center, load aggregation providers, electric power companies, and other subjects. The specific process includes: performing the initial configuration, training the feature identification model offline, training the elasticity estimation model offline, calculating the real-time load response and elasticity online, determining whether the system constraint is satisfied, constructing and solving the incremental optimization model, determining whether the convergence is reached, and organizing and outputting the results. The method of the present disclosure specifically adopts two key techniques, namely the neural network and the iterative co-training of the neural network based optimization model, which can greatly improve the accuracy of the flexible load aggregation and optimization under the premise of avoiding the privacy leak, and is applicable to different types of flexible loads, can greatly improve the operational efficiency and management level of the resources on the load side, and has a bright prospect for industrial application.

The apparatus embodiments of the present disclosure are described that can be used to perform the method embodiments of the present disclosure. For details not disclosed in the apparatus embodiments of the present disclosure, please refer to the method embodiments of the present disclosure.

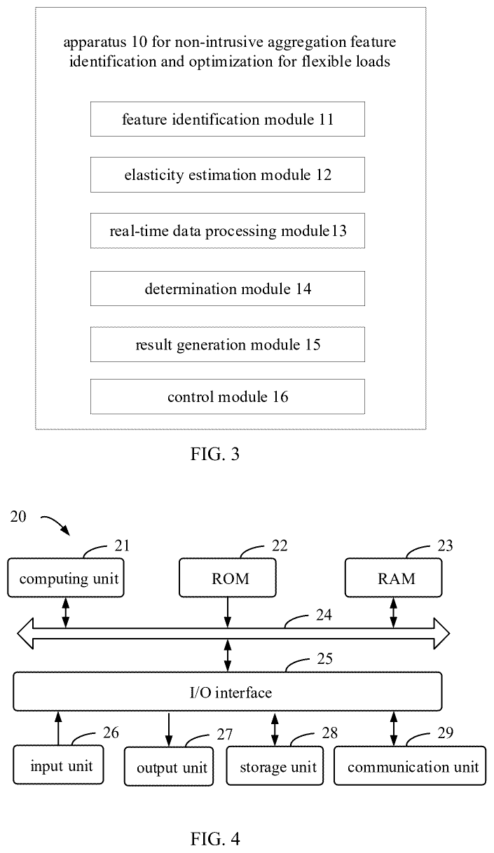

Referring to FIG. 3, it is a block diagram illustrating an apparatus for non-intrusive aggregation and optimal control of flexible loads according to an embodiment of the present disclosure. The apparatus 10 includes a feature identification module 11, an elasticity estimation module 12, a real-time data processing module 13, a determination module 14, a result generation module 15, and a control module 16.

The feature identification module 11 is configured to obtain a feature identification model oriented to the flexible loads, in which an input of the feature identification model is an incentive price, and an output of the feature identification model is a responsive electricity consumption.

The elasticity estimation module 12 is configured to obtain an elasticity estimation model oriented to the flexible loads, in which an input of the elasticity estimation model is the incentive price, and an output of the elasticity estimation model is a virtual elasticity matrix.

The real-time data processing module 13 is configured to obtain an incentive price for a current round in real time, output a real-time responsive electricity consumption by inputting the incentive price for the current round into the feature identification model, and output a real-time virtual elasticity matrix by inputting the incentive price for the current round into the elasticity estimation model.

The determination module 14 is configured to determine whether a system security constraint is satisfied based on the real-time responsive electricity consumption and the real-time virtual elasticity matrix, in response to determine that the system security constraint is satisfied, generate a constraint satisfaction instruction, and in response to determine that the system security constraint is not satisfied, generate a constraint non-satisfaction instruction.

The result generation module 15 is configured to in response to receive the constraint satisfaction instruction, determine the incentive price for the current round is an optimal incentive price, and the real-time responsive electricity consumption is an optimal responsive electricity consumption; and in response to receive the constraint non-satisfaction instruction, construct an incremental optimization model based on the incentive price for the current round, the real-time responsive electricity consumption and the real-time virtual elasticity matrix, and obtain the optimal incentive price and the optimal responsive electricity consumption based on the incremental optimization model.

The control module 16 is configured to perform non-invasive aggregation and optimal control of the flexible loads based on the optimal incentive price and the optimal responsive electricity consumption.

In some embodiments, the determination module 14 is further configured to obtain an optimal incentive price for an adjacent round, and determine whether a convergence stop condition is satisfied based on the optimal incentive price for the adjacent round; in response to determine that the convergence stop condition is satisfied, generate a convergence satisfaction instruction, and in response to determine that the convergence stop condition is not satisfied, generate a convergence non-satisfaction instruction.

In some embodiments, the control module 16 is further configured to in response to receive the convergence satisfaction instruction, perform non-invasive aggregation and optimal control of the flexible loads based on the optimal incentive price and the optimal responsive electricity consumption.

In some embodiments, the real-time data processing module 13 is further configured to, in response to determining that the convergence stop condition is not satisfied, updating the current round, and obtaining a new optimal incentive price and a new optimal responsive electricity consumption based on an updated incentive price for the current round obtained in real time.

In some embodiments, a multi-input and multi-output machine learning model is used in the feature identification model, in which a plurality of inputs of the feature identification model are incentive prices for a plurality of time periods, and a plurality of outputs of the feature identification model are responsive electricity consumptions for respective time periods.

In some embodiments, a multi-input and multi-output machine learning model is used in the elasticity estimation model, in which a plurality of inputs of the elasticity estimation model are incentive prices for the plurality of time periods, and a plurality of outputs of the elasticity estimation model are virtual elasticity matrixes for respective time periods.

In some embodiments, a hyperparameter optimization method is used in each of the feature identification model and the elasticity estimation model in a training process.

In some embodiments, before the feature identification module 11 obtains the feature identification model oriented to the flexible loads and before the elasticity estimation module 12 obtains the elasticity estimation model oriented to the flexible loads, the control module 16 is further configured to perform an initial configuration.

It should be noted that the foregoing explanations of the embodiment of the method for non-intrusive aggregation and optimal control of flexible loads are also applicable to the apparatus embodiment, which will not be repeated herein.

In the apparatus according to the embodiments of the present disclosure, the feature identification module obtains the feature identification model oriented to the flexible loads, in which the input of the feature identification model is the incentive price, and the output of the feature identification model is the responsive electricity consumption; the elasticity estimation module obtains the elasticity estimation model oriented to the flexible loads, in which the input of the elasticity estimation model is the incentive price, and the output of the elasticity estimation model is the virtual elasticity matrix; the real-time data processing module obtains the incentive price for the current round in real time, output the real-time responsive electricity consumption by inputting the incentive price for the current round into the feature identification model, and output the real-time virtual elasticity matrix by inputting the incentive price for the current round into the elasticity estimation model; the determination module determines whether the system security constraint is satisfied based on the real-time responsive electricity consumption and the real-time virtual elasticity matrix, in response to determine that the system security constraint is satisfied, generates the constraint satisfaction instruction, and in response to determine that the system security constraint is not satisfied, generates the constraint non-satisfaction instruction; the result generation module determines, in response to receive the constraint satisfaction instruction, the incentive price for the current round is the optimal incentive price, and the real-time responsive electricity consumption is the optimal responsive electricity consumption, constructs, in response to receive the constraint non-satisfaction instruction, an incremental optimization model based on the incentive price for the current round, the real-time responsive electricity consumption and the real-time virtual elasticity matrix, and obtains the optimal incentive price and the optimal responsive electricity consumption based on the incremental optimization model; the control module performs non-invasive aggregation and optimal control of the flexible loads based on the optimal incentive price and the optimal responsive electricity consumption. In this way, the feature identification model oriented to the flexible loads is combined with the elasticity estimation model oriented to the flexible loads and the incremental optimization model with the iterative co-training, to obtain the optimal incentive price and the optimal responsive electricity consumption, further to perform non-intrusive aggregation and optimal control of flexible loads. As a result, the aggregation and optimization accuracy of the flexible loads can be improved. In addition, considering the non-intrusive identification technique removes information reporting, a statistical method is used to establish an equivalent mapping relationship of the external features. The apparatus of the present disclosure performs a series of developments based on this technique. Specifically, a new type of non-intrusive identification technique is established based on the neural network, which is applied to the identification task of the flexible load aggregation feature. The aggregation and optimization technique with the in-built identification model is further proposed, which is mainly oriented to a distribution network dispatching organization, a microgrid control center, load aggregation providers, electric power companies, and other subjects. The specific process includes: performing the initial configuration, training the feature identification model offline, training the elasticity estimation model offline, calculating the real-time load response and elasticity online, determining whether the system constraint is satisfied, constructing and solving the incremental optimization model, determining whether the convergence is reached, and organizing and outputting the results. The apparatus of the present disclosure specifically adopts two key techniques, namely the neural network and the iterative co-training of the neural network based optimization model, which can greatly improve the accuracy of the flexible load aggregation and optimization under the premise of avoiding the privacy leak, and is applicable to different types of flexible loads, can greatly improve the operational efficiency and management level of the resources on the load side, and has a bright prospect for industrial application.

According to embodiments of the present disclosure, a device for non-intrusive aggregation and optimal control of flexible loads, a readable storage medium, and a computer program product are also provided.

Referring to FIG. 4, it is a block diagram illustrating a device 20 for non-intrusive aggregation and optimal control of flexible loads used to implement the above-mentioned methods according to an embodiment of the present disclosure. The device 20 is intended to represent various types of digital computers, such as laptop computers, desktop computers, workstations, personal digital assistants, servers, blade servers, mainframe computers, and other suitable computers. The device 20 may also represent various types of mobile devices, such as personal digital assistants, cellular phones, smart phones, wearable devices, and other similar computing devices. The components shown herein, their connections and relations, and their functions are merely examples, which are not intended to limit the implementations of the disclosure described and/or required herein.

As shown in FIG. 4, the device 20 includes a computing unit 21 that may execute various appropriate actions and processes according to a computer program stored in a read-only memory (ROM) 22 or loaded from a storage unit 28 to a random access memory (RAM) 23. In the RAM 23, various programs and data required for the device 20 may be stored. The computing unit 21, the ROM 22 and the RAM 23 may be connected with each other by a bus 24. An input/output (I/O) interface 25 is also connected to the bus 24.

A plurality of components in the device 20 are connected to the I/O interface 25, and include: an input unit 26, for example, a keyboard, a mouse; an output unit 27, for example, various types of displays, speakers; a storage unit 28, for example, a magnetic disk, an optical disk, the storage unit 28 being communicatively connected to the computing unit 21; and a communication unit 29, for example, a network card, a modem, a wireless transceiver. The communication unit 29 allows the device 20 to exchange information/data with other devices through a computer network such as Internet and/or various types of telecommunication networks.

The computing unit 21 may be various types of general and/or dedicated processing components with a processing and computing capability. Some examples of the computing unit 21 include but not limited to a central processing unit (CPU), a graphics processing unit (GPU), various dedicated artificial intelligence (AI) computing chips, various computing units running a machine learning model algorithm, a digital signal processor (DSP), and any appropriate processor, controller, microcontroller, etc. The computing unit 21 executes various methods and processes as described above, for example, the above-mentioned methods. For example, in some embodiments, the above-mentioned methods may be further implemented as a computer software program, which is physically contained in a machine readable medium, such as the storage unit 28. In some embodiments, a part or all of the computer program may be loaded and/or installed on the device 20 via the ROM 22 and/or the communication unit 29. When the computer program is loaded on the RAM 23 and executed by the computing unit 21, one or more steps in the method as described above may be performed. Alternatively, in other embodiments, the computing unit 21 may be configured to perform the method for non-intrusive aggregation and optimal control of flexible loads in other appropriate ways (for example, by virtue of a firmware).

Various implementation modes of systems and technologies described herein may be implemented in a digital electronic circuit system, an integrated circuit system, a field programmable gate array (FPGA), a dedicated application specific integrated circuit (ASIC), an application specific standard product (ASSP), a system on chip (SOC), a complex programmable logic device (CPLD), computer hardware, a firmware, software, and/or combinations thereof. The implementations may include: being implemented in one or more computer programs. The one or more computer programs may be executed and/or interpreted on a programmable system including at least one programmable processor. The programmable processor may be a dedicated or general-purpose programmable processor, may receive data and instructions from a storage system, at least one input device, and at least one output device, and transmit the data and the instructions to the storage system, the at least one input device, and the at least one output device.

The computer code configured to execute the method in the present disclosure may be written with one or any combination of a plurality of programming languages. These programming languages may be provided to a processor or a controller of a general-purpose computer, a dedicated computer, or other programmable devices for data processing so that the function/operation specified in the flowchart and/or block diagram may be performed when the program code is executed by the processor or controller. The computer code may be executed completely or partly on the machine, executed partly on the machine as an independent software package and partly on the remote machine or server, or completely on the remote machine or server.

In the embodiment of the present disclosure, a machine-readable medium may be a tangible medium that may contain or store a program intended for use in or in conjunction with an instruction execution system, apparatus or device. The machine-readable medium may be a machine-readable signal medium or a machine-readable storage medium. The machine-readable medium may include but not limited to an electronic, magnetic, optical, electromagnetic, infrared, or semiconductor system, apparatus or device, or any appropriate combination thereof. A more specific example of the machine readable storage medium includes an electronic connector with one or more cables, a portable computer disk, hardware, a RAM, a ROM, an erasable programmable ROM (an EPROM or a flash memory), an optical fiber device, and a portable optical disk ROM (CD-ROM), an optical storage device, a magnetic storage device, or any appropriate combination of the above.

In order to provide interaction with the user, the systems and techniques described here may be implemented on a computer, and the computer has: a display device for displaying information to the user (for example, a CRT (cathode ray tube) or a LCD (liquid crystal display) monitor); and a keyboard and a pointing device (for example, a mouse or a trackball) through which the user may provide input to the computer. Other types of devices may further be configured to provide interaction with the user. The feedback provided to the user may be any form of sensory feedback (for example, a visual feedback, an auditory feedback, or a tactile feedback); and input from the user may be received in any form (including an acoustic input, a voice input or a tactile input).

The systems and techniques described herein may be implemented in a computing system (for example, as a data server) including a back-end component, or a computing system (for example, an application server) including a middleware component, or a computing system including a front-end component (for example, a user computer with a graphical user interface or a web browser, via which the user may interact with implementations of the systems and techniques described herein), or in a computing system including any combination of the back-end component, the middleware component, or the front-end component. Components of the system may be interconnected by any form or medium of digital data communication (for example, a communication network). Examples of the communication network include a local area network (LAN), a wide area network (WAN), an Internet, and a blockchain network.

The computer system may include a client and a server. The client and the server are generally far away from each other and generally interact with each other through a communication network. The relationship between the client and the server is generated by computer programs that run on the corresponding computer and have a client-server relationship with each other. The server may be a cloud server, also known as a cloud computing server or a cloud host, is a host product in a cloud computing service system, to solve the shortcomings of large management difficulty and weak business expansibility existed in the conventional physical host and a virtual private server (VPS) service. The server further may be a server with a distributed system, or a server in combination with a blockchain.

It should be noted that various forms of processes shown above may be used to reorder, add, or delete the steps. For example, the steps described in the present disclosure may be executed in parallel, sequentially, or in a different order, as long as the desired result of the technical solution disclosed in the present disclosure may be achieved, which will not be limited herein.

The above implementations do not constitute a limitation of the protection scope of the disclosure. Those skilled in the art shall understand that various modifications, combinations and sub-combinations and substitutions may be made. Any modification, equivalent substitution and improvement, etc., made within the principle of the present disclosure shall be included within the protection scope of the present disclosure.

1. A computer-implemented method for non-intrusive aggregation and optimal control of flexible loads, comprising:
constructing a feature identification model oriented to the flexible loads, wherein an input of the feature identification model is an incentive price, and an output of the feature identification model is a responsive electricity consumption;
constructing an elasticity estimation model oriented to the flexible loads, wherein an input of the elasticity estimation model is the incentive price, and an output of the elasticity estimation model is a virtual elasticity matrix;
generating an incentive price for a current round in real time, outputting a real-time responsive electricity consumption by inputting the incentive price for the current round into the feature identification model, and outputting a real-time virtual elasticity matrix by inputting the incentive price for the current round into the elasticity estimation model;
determining whether a system security constraint is satisfied based on the real-time responsive electricity consumption and the real-time virtual elasticity matrix;
in response to determining that the system security constraint is satisfied, determining the incentive price for the current round is an optimal incentive price, and the real-time responsive electricity consumption is an optimal responsive electricity consumption;
in response to determining that the system security constraint is not satisfied, constructing an incremental optimization model based on the incentive price for the current round, the real-time responsive electricity consumption and the real-time virtual elasticity matrix, and obtaining the optimal incentive price and the optimal responsive electricity consumption based on the incremental optimization model; and
performing non-invasive aggregation and optimal control of the flexible loads based on the optimal incentive price and the optimal responsive electricity consumption.

2. The method of claim 1, further comprising:
obtaining an optimal incentive price for an adjacent round, and determining whether a convergence stop condition is satisfied based on the optimal incentive price for the adjacent round;
in response to determining that the convergence stop condition is satisfied, performing non-invasive aggregation and optimal control of the flexible loads based on the optimal incentive price and the optimal responsive electricity consumption; and
in response to determining that the convergence stop condition is not satisfied, updating a coefficient of the current round, and obtaining a new optimal incentive price and a new optimal responsive electricity consumption based on an incentive price for an updated round obtained in real time.

3. The method of claim 1, wherein the feature identification model is a multi-input and multi-output machine learning model, a plurality of inputs of the feature identification model are incentive prices for a plurality of time periods, and a plurality of outputs of the feature identification model are responsive electricity consumptions for the plurality of time periods, and
the elasticity estimation model is a multi-input and multi-output machine learning model, a plurality of inputs of the elasticity estimation model are incentive prices for the plurality of time periods, and a plurality of outputs of the elasticity estimation model are virtual elasticity matrixes for the plurality of time periods.

4. The method of claim 3, wherein a hyperparameter optimization method is used in each of the feature identification model and the elasticity estimation model in a training process.

5. The method of claim 1, wherein constructing the incremental optimization model comprises:
constructing an objective function of the incremental optimization model;
constructing constraints of the incremental optimization model; and
constituting the incremental optimization model based on the objective function and the constraints.

6. The method of claim 1, wherein before obtaining the feature identification model oriented to the flexible loads and the elasticity estimation model oriented to the flexible loads, the method further comprises: performing an initial configuration.

7. The method of claim 6, wherein performing the initial configuration comprises checking a communication network state, importing a historical database, importing a historical empirical model, and reading various parameters and performance requirements for aggregation and optimization.

8.-12. (canceled)

13. A device for non-intrusive aggregation and optimal control of flexible loads, comprising:
at least one processor; and
a memory communicatively coupled to the at least one processor;
wherein the memory stores instructions which, when executed by the at least one processor, the at least one processor is configured to:
construct a feature identification model oriented to the flexible loads, wherein an input of the feature identification model is an incentive price, and an output of the feature identification model is a responsive electricity consumption;
construct an elasticity estimation model oriented to the flexible loads, wherein an input of the elasticity estimation model is the incentive price, and an output of the elasticity estimation model is a virtual elasticity matrix;
generate an incentive price for a current round in real time, output a real-time responsive electricity consumption by inputting the incentive price for the current round into the feature identification model, and output a real-time virtual elasticity matrix by inputting the incentive price for the current round into the elasticity estimation model;
determine whether a system security constraint is satisfied based on the real-time responsive electricity consumption and the real-time virtual elasticity matrix;
in response to determining that the system security constraint is satisfied, determine the incentive price for the current round is an optimal incentive price, and the real-time responsive electricity consumption is an optimal responsive electricity consumption;
in response to determining that the system security constraint is not satisfied, construct an incremental optimization model based on the incentive price for the current round, the real-time responsive electricity consumption and the real-time virtual elasticity matrix, and obtain the optimal incentive price and the optimal responsive electricity consumption based on the incremental optimization model; and
perform non-invasive aggregation and optimal control of the flexible loads based on the optimal incentive price and the optimal responsive electricity consumption.

14. A non-transitory computer-readable storage medium storing an instruction which, when executed by a processor of an electronic device, causes the electronic device to perform a method for non-intrusive aggregation and optimal control of flexible loads, wherein the method comprises:
constructing a feature identification model oriented to the flexible loads, wherein an input of the feature identification model is an incentive price, and an output of the feature identification model is a responsive electricity consumption;
constructing an elasticity estimation model oriented to the flexible loads, wherein an input of the elasticity estimation model is the incentive price, and an output of the elasticity estimation model is a virtual elasticity matrix;
generating an incentive price for a current round in real time, outputting a real-time responsive electricity consumption by inputting the incentive price for the current round into the feature identification model, and outputting a real-time virtual elasticity matrix by inputting the incentive price for the current round into the elasticity estimation model;
determining whether a system security constraint is satisfied based on the real-time responsive electricity consumption and the real-time virtual elasticity matrix;
in response to determining that the system security constraint is satisfied, determining the incentive price for the current round is an optimal incentive price, and the real-time responsive electricity consumption is an optimal responsive electricity consumption;
in response to determining that the system security constraint is not satisfied, constructing an incremental optimization model based on the incentive price for the current round, the real-time responsive electricity consumption and the real-time virtual elasticity matrix, and obtaining the optimal incentive price and the optimal responsive electricity consumption based on the incremental optimization model; and
performing non-invasive aggregation and optimal control of the flexible loads based on the optimal incentive price and the optimal responsive electricity consumption.

15. (canceled)

16. The device of claim 13, wherein the at least one processor is further configured to:
obtain an optimal incentive price for an adjacent round, and determining whether a convergence stop condition is satisfied based on the optimal incentive price for the adjacent round;
in response to determining that the convergence stop condition is satisfied, perform non-invasive aggregation and optimal control of the flexible loads based on the optimal incentive price and the optimal responsive electricity consumption; and
in response to determining that the convergence stop condition is not satisfied, update a coefficient of the current round, and obtain a new optimal incentive price and a new optimal responsive electricity consumption based on an incentive price for an updated round obtained in real time.

17. The device of claim 13, wherein the feature identification model is a multi-input and multi-output machine learning model, a plurality of inputs of the feature identification model are incentive prices for a plurality of time periods, and a plurality of outputs of the feature identification model are responsive electricity consumptions for the plurality of time periods, and
the elasticity estimation model is a multi-input and multi-output machine learning model, a plurality of inputs of the elasticity estimation model are incentive prices for the plurality of time periods, and a plurality of outputs of the elasticity estimation model are virtual elasticity matrixes for the plurality of time periods.

18. The device of claim 17, wherein a hyperparameter optimization method is used in each of the feature identification model and the elasticity estimation model in a training process.

19. The device of claim 13, wherein the at least one processor is further configured to: construct an objective function of the incremental optimization model and constraints of the incremental optimization model; and constitute the incremental optimization model based on the objective function and the constraints.

20. The device of claim 13, wherein before obtaining the feature identification model oriented to the flexible loads and the elasticity estimation model oriented to the flexible loads, the at least one processor is further configured to perform an initial configuration.

21. The device of claim 20, wherein the at least one processor is further configured to: check a communication network state, import a historical database and a historical empirical model, and read various parameters and performance requirements for aggregation and optimization.

22. The storage medium of claim 14, wherein the method further comprises:
obtaining an optimal incentive price for an adjacent round, and determining whether a convergence stop condition is satisfied based on the optimal incentive price for the adjacent round;
in response to determining that the convergence stop condition is satisfied, performing non-invasive aggregation and optimal control of the flexible loads based on the optimal incentive price and the optimal responsive electricity consumption; and
in response to determining that the convergence stop condition is not satisfied, updating a coefficient of the current round, and obtaining a new optimal incentive price and a new optimal responsive electricity consumption based on an incentive price for an updated round obtained in real time.

23. The storage medium of claim 14, wherein the feature identification model is a multi-input and multi-output machine learning model, a plurality of inputs of the feature identification model are incentive prices for a plurality of time periods, and a plurality of outputs of the feature identification model are responsive electricity consumptions for the plurality of time periods, and
the elasticity estimation model is a multi-input and multi-output machine learning model, a plurality of inputs of the elasticity estimation model are incentive prices for the plurality of time periods, and a plurality of outputs of the elasticity estimation model are virtual elasticity matrixes for the plurality of time periods.

24. The storage medium of claim 23, wherein a hyperparameter optimization method is used in each of the feature identification model and the elasticity estimation model in a training process.

25. The storage medium of claim 14, wherein constructing the incremental optimization model comprises:
constructing an objective function of the incremental optimization model;
constructing constraints of the incremental optimization model; and
constituting the incremental optimization model based on the objective function and the constraints.

26. The storage medium of claim 14, wherein before obtaining the feature identification model oriented to the flexible loads and the elasticity estimation model oriented to the flexible loads, the method further comprises: performing an initial configuration.
